(19) United States
(12) Patent Application Publication
(10) Pub. No.: US 2026/0193042 A1
(43) Pub. Date: Jul. 9, 2026

(54) IMPROVEMENTS IN, OR RELATING TO GRADING APPARATUS AND METHODS

(71) Applicant: KENNEDY TECHNOLOGIES LIMITED, Auckland (NZ)

(72) Inventors: Hamish Alexander Nigel Kennedy, Auckland (NZ); Finn Marcus KENNEDY, Auckland (NZ)

(21) Appl. No.: 19/132,607

(22) PCT Filed: Nov. 27, 2023
(86) PCT No.: PCT/IB2023/061937

§ 371 Date: May 23, 2025

(30) Foreign Application Priority Data
Nov. 25, 2022 (NZ) 794951
Aug. 4, 2023 (NZ) 802544
Sep. 28, 2023 (NZ) 804158

(51) Int. Cl. B65G 17/12; B65G 17/20; B65G 17/32; B65G 17/48; B65G 47/96

(52) U.S. Cl. CPC B65G 17/12; B65G 17/20; B65G 17/32; B65G 17/485; B65G 47/962

(57) ABSTRACT

An article carrier has a bracket configured for attaching the article carrier to a conveyor, and a carrier frame configured to support an article, a bearing surface configured to co-operate with the carrier frame whereby the carrier frame is separably pivotally supported by the bracket such that the carrier frame is able to pivot relative to the bracket about a longitudinal axis, and a tipping surface configured to contact an actuator to tip the carrier frame about the longitudinal axis, wherein the tipping surface is located at or above a weighing surface.

### TECHNICAL FIELD OF THE INVENTION

The present invention relates to grading apparatus, and is directed to article carriers, tipping actuators and related conveying systems for use in grading articles such as fruit.

### BACKGROUND OF THE INVENTION

Article carriers are often used in fruit graders to transport fruit through various measurement stages for grading purposes and to eject fruit at a required location dependent on the result of the grading process.

Fruit graders usually comprise an endless circuit of carriers or “cups” on a conveyor chain with the cups situated to unload fruit at stations appropriate to, for example, fruit weight, size, colour or defect type. There are currently two predominant methods of sizing fruit, being weighing and imaging (using a video image to gain information about the fruit). The weighing method requires that the fruit are separated, that is one per cup, and that the cup be stable with minimum external forces so that weight can be measured accurately. The imaging method requires that fruit be rotated between large diameter rollers in order that multiple views may be obtained (especially for non-spherically shaped fruit). Many different designs of cup and their actuating system are known to the prior art. An example of the prior art is shown in U.S. Pat. No. 6,003,653 which is incorporated herein by reference.

The actuating systems tip a portion of the carrier to dislodge the fruit they are carrying at the required location. This may involve rotating a cup part of the carrier about a longitudinal axis (which is aligned with the direction of propagation of the conveyer, i.e., the direction in which the carrier is moved by the conveyor). The cup of the carrier may also need to rotate about a transverse axis (i.e., an axis which is transverse or perpendicular to the longitudinal axis). Also, there needs to be freedom of movement for the cup part to be able to float freely of the body of the carrier to enable the item of fruit to be weighed.

These various ranges of movement impose difficult design constraints, and existing constructions can often get jammed, or stick or become unstable in use. These problems can greatly reduce the overall performance of a sorting or grading system.

It is an object of invention to provide an article carrier or a sorting or conveying apparatus which addresses disadvantages of known constructions, or which at least provides a useful alternative to known constructions.

### BRIEF DESCRIPTION OF THE INVENTION

Some non-limiting aspects of the invention are set forth in the appended claims. The various aspects described below and in the specification as a whole can be combined in any various permutations, as will be seen from the description further below.

Other aspects of the invention will be apparent from the following description.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples only.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

As used herein the term “and/or” means “and” or “or”, both. As used herein “(s)” following a noun means the plural and/or singular forms of the noun. The term “comprising” as used in this specification means “consisting at least in part of”. When interpreting statements in this specification which include that term, the features prefaced by that term in each statement all need to be present, but the other features can also be present. Related terms such as “comprise” and “comprised” are to be interpreted in the same matter. The entire disclosures of all applications, patents and publications, cited above and below, if any, are hereby incorporated by reference.

An article carrier is disclosed, comprising:
a bracket configured for attaching the article carrier to a conveyor, the bracket having a longitudinal axis and a carrier frame support surface;
a carrier frame configured to support an article, the carrier frame having a support leg comprising a bearing surface configured to co-operate with the carrier frame support surface whereby the carrier frame is separably pivotally supported by the bracket such that the carrier frame is able to pivot relative to the bracket about the longitudinal axis, and wherein:
   the support leg further comprises a limit means to limit longitudinal movement of the carrier relative to the bracket.

Optionally, the limit means comprises at least one abutment portion on the support leg.

Optionally, the limit means is configured to limit longitudinal movement of the carrier relative to the bracket while the carrier frame pivots about the longitudinal axis.

Optionally, the limit means is located on a leading end of the support leg.

Optionally, the limit means is located on a trailing end of the support leg.

An article carrier is disclosed, comprising:
a bracket configured for attaching the article carrier to a conveyor, the bracket having a longitudinal axis and a carrier frame support surface;
a carrier frame configured to support an article, the carrier frame having a support leg comprising a bearing surface configured to co-operate with the carrier frame support surface whereby the carrier frame is separably pivotally supported by the bracket such that the carrier frame is able to pivot relative to the bracket about the longitudinal axis, and wherein:
   the carrier frame support surface is provided at an inclined angle in use such that it rises from a trailing end to a leading end.

Optionally, the carrier frame further comprises a lip configured to abut the trailing end of the carrier frame support surface.

An article carrier is disclosed, comprising:
a bracket configured for attaching the article carrier to a conveyor, the bracket having a longitudinal axis and a carrier frame support surface;
a carrier frame configured to support an article, the carrier frame having a connector member which connects the carrier frame to the bracket such that the carrier frame is able to pivot relative to the bracket about the longitudinal axis, and wherein:
   the bracket comprises a cavity configured to receive part of the connector member, and the cavity having a mouth configured to allow the part of the connector member to enter or exit the cavity.

Optionally, the mouth is defined by jaws and one of the jaws is configured to move to allow the connector member to enter or exit the cavity.

An article carrier is disclosed, comprising:
a bracket configured for attaching the article carrier to a conveyor;
a carrier frame configured to support an article;
   a pivot means configured such that a carrier frame is able to pivot relative to the bracket along a longitudinal axis of the bracket and along a transverse axis that extends transversely to the longitudinal axis, wherein:
   the carrier frame comprises an abutting portion configured to prevent longitudinal movement while the carrier frame pivots about the longitudinal axis.

An article carrier is disclosed, comprising:
a bracket configured for attaching the article carrier to a conveyor;
a carrier frame configured to support an article;
   a pivot means configured such that a carrier frame is able to pivot relative to the bracket along a longitudinal axis of the bracket, wherein:
   the carrier frame comprises an abutting portion configured to prevent longitudinal movement in one longitudinal direction.

An article carrier is disclosed, comprising:
a bracket configured for attaching the article carrier to a conveyor;
a carrier frame configured to support an article;
   a pivot means such that a carrier frame is able to pivot along a longitudinal axis of the bracket and along a transverse axis that extends transversely to the longitudinal axis, wherein the bracket comprises a surface configured to contact a corresponding surface of the article carrier to prevent further movement of the carrier frame about the transverse axis.

An article carrier is disclosed, comprising:
a bracket configured for attaching the article carrier to a conveyor, the bracket having a longitudinal axis and a carrier frame support surface;
a carrier frame configured to support an article, the carrier frame having a support leg comprising a bearing surface configured to co-operate with the carrier frame support surface whereby the carrier frame is separably pivotally supported by the bracket such that the carrier frame is able to pivot relative to the bracket about the longitudinal axis to a tipping position, and wherein:
   the bearing surface and the support surface are complementarily contoured to centre the support leg relative to the bracket and/or to bias the carrier to a carrying or non-tipping position.

Optionally, one of the bearing surface or support surface comprises a recess contoured to bias the carrier to a carrying position.

Optionally, a shoulder is provided either side of the recess.

Optionally, the recess comprises a base and an angled wall either side of the base.

An article carrier is disclosed, comprising:
a bracket configured for attaching the article carrier to a conveyor, the bracket having a longitudinal axis and a carrier frame support surface;
a carrier frame having a roller configured to support an article, a bearing surface configured to co-operate with the carrier frame support surface whereby the carrier frame is separably pivotally supported by the bracket such that the carrier frame is able to pivot relative to the bracket about the longitudinal axis, and a tipping surface configured to contact an actuator to tip the carrier frame about the longitudinal axis, wherein the tipping surface is located at or above a weighing surface.

An article carrier is disclosed, comprising:
a bracket configured for attaching the article carrier to a conveyor, the bracket having a longitudinal axis and a carrier frame support surface;
a carrier frame having a roller configured to support an article, a bracket support surface configured to co-operate with the carrier frame support surface whereby the carrier frame is separably pivotally supported by the bracket such that the carrier frame is able to pivot relative to the bracket about a transverse axis which is transverse to the longitudinal axis, a front tipping surface configured to contact an actuator to tip the carrier frame about the transverse axis, a side tipping surface configured to contact an actuator to tip the carrier frame about a longitudinal axis, and wherein the front tipping surface is located below the side tipping surface.

An article carrier is disclosed according to any one or more of the statements above.

An article carrier bracket is disclosed, comprising:
a body including a support means for supporting a carrier frame, two resilient legs extending from the body, each leg having a proximal end proximate to the body and a distal end remote from the body, the legs being separated from each other whereby the distal ends define an opening for receiving a part of a conveyor, each leg including an engagement formation for engaging with the conveyor part, and a web member extending from the proximal end of one leg to the proximal end of the other leg, the web member being configured to provide a structural connection between the proximal ends of the legs.

Optionally, the bracket for any of the article carriers referred to above comprises a bracket according to the preceding statement.

A tipping actuator for a conveyor system is disclosed, the tipping actuator comprising:
a frame;
a trigger member pivotally mounted on the frame by a pivot connection and moveable between a non-triggering position and a triggering position;
a plurality of actuators, the actuators being energisable to move the trigger member to the non-triggering position or the triggering position, wherein one actuator is mounted closer to the pivot than the other.

Optionally, the trigger comprises a carrier contacting surface and the trigger is configured to rotate upwardly into the triggering position whereby the carrier contacting surface is oriented to contact an article carrier to thereby tip the carrier.

Optionally, the carrier contacting surface is provided on one side of the pivot connection and an arm is provided on the other side of the pivot connection.

Optionally, the actuators act on the arm to move the trigger member to the non-triggering position or triggering position.

An article carrier system or a conveyor system is disclosed comprising one or more article carriers according any of the preceding statements and one or more tipping actuators according to any of the preceding statements.

In an aspect an article carrier is disclosed, comprising:
a bracket configured for attaching the article carrier to a conveyor, the bracket having a longitudinal axis and a carrier frame support surface;
a carrier frame having a roller configured to support an article, a bearing surface configured to co-operate with the carrier frame support surface whereby the carrier frame is separably pivotally supported by the bracket such that the carrier frame is able to pivot relative to the bracket about the longitudinal axis, and a tipping surface configured to contact an actuator to tip the carrier frame about the longitudinal axis, wherein the tipping surface is located at or above at least one or a weighing surface and an axis of the roller.

The tipping surface may be located at or above at the weighing surface. The weighing surface may be provided to one or both sides of the tipping surface. The weighing surface may be provided to one or both sides of the tipping surface.

The tipping surface may extend longitudinally from an edge of the roller to the axis of the roller.

The carrier frame can include a further tipping surface configured to contact an actuator to tip the carrier frame about a transverse axis, the further tipping surface being located below at least one of the tipping surface and the axis of the roller.

The carrier frame can include a support leg comprising the bearing surface and wherein the support leg further comprises a limit means to limit longitudinal movement of the carrier relative to the bracket. The limit means can comprise at least one abutment portion on the support leg. The limit means can be configured to limit longitudinal movement of the carrier relative to the bracket while the carrier frame pivots about the longitudinal axis. The limit means can be located on a leading end of the support leg. Alternatively, or additionally, the limit means can be located on a trailing end of the support leg.

The carrier frame support surface can be provided at an inclined angle in use such that it rises from a trailing end to a leading end.

The carrier frame can be configured to pivot about a transverse axis that extends transversely to the longitudinal axis, wherein the bracket comprises a surface configured to contact a corresponding surface of the article carrier to prevent further movement of the carrier frame about the transverse axis.

The bearing surface and the support surface can be complementarily contoured to centre the support leg relative to the bracket and/or to bias the carrier to a carrying or non-tipping position.

The bracket can be configured to include:
a body including a support means for supporting the carrier frame, two resilient legs extending from the body, each leg having a proximal end proximate to the body and a distal end remote from the body, the legs being separated from each other whereby the distal ends define an opening for receiving a part of a conveyor, each leg including an engagement formation for engaging with the conveyor part, and a web member extending from the proximal end of one leg to the proximal end of the other leg, the web member being configured to provide a structural connection between the proximal ends of the legs.

The roller can be configured to include:
a hub portion configured to provide or receive an axle, the hub portion comprising a first material having a first hardness;
an article contact portion engaged with the hub portion, the article contact portion being configured to at least partially support an article, and comprising a second material having a second hardness, and
wherein the second hardness is less than the first hardness.

In another aspect a conveyor is disclosed, comprising at least one article carrier of any of the preceding statements and a tipping actuator.

The tipping actuator can be configured to comprise:
a frame;
a trigger member pivotally mounted on the frame by a pivot connection and moveable between a non-triggering position and a triggering position;
a plurality of actuators, the actuators being energisable to move the trigger member to the non-triggering position or the triggering position, wherein one actuator is mounted closer to the pivot than the other.

The trigger can comprise a carrier contacting surface and the trigger is configured to rotate upwardly into the triggering position whereby the carrier contacting surface is oriented to contact an article carrier to thereby tip the carrier.

The carrier contacting surface can be provided on one side of the pivot connection and an arm can be provided on the other side of the pivot connection. The actuators can act on the arm to move the trigger member to the non-triggering position or triggering position.

Further aspects will be apparent from the following description.

### BRIEF DESCRIPTION OF THE DRAWINGS

Preferred forms of the present invention will now be described with reference to the accompanying drawings in which the figures show elevations and isometric views of individual parts of the article carrier and show the assembled article.

FIG. 1 is a side view of a bracket for an article carrier;

FIG. 2 is a front view of the bracket of FIG. 1;

FIG. 3 is a rear view of the bracket of FIGS. 1 and 2;

FIG. 4 is a perspective view of the bracket of FIGS. 1-3;

FIG. 5 is a perspective view of the bracket of FIGS. 1-3;

FIG. 6 is a side view of a carrier frame for an article carrier;

FIG. 7 is a front view of the carrier frame of FIG. 6;

FIG. 8 is a perspective view of a bracket of the carrier frame;

FIG. 9 is a perspective view of the carrier frame of FIG. 6;

FIG. 10 is a perspective view of the carrier frame of FIG. 6;

FIG. 11 is a side view of an article carrier including the bracket and carrier frame of FIGS. 1 and 6 mounted on a conveyor;

FIG. 12 is a front view of the article carrier of FIG. 11;

FIG. 13 is a perspective view of the article carrier of FIG. 11;

FIG. 14 is another view of FIG. 12, showing the carrier frame in a side tipped position;

FIG. 15 is a perspective view of FIG. 14;

FIG. 16 is another view of FIG. 11 with the carrier frame disposed in a front tipping position;

FIG. 17 is a perspective view of FIG. 11;

FIG. 18 is another view of FIG. 11 in cross-section, without the conveyor;

FIG. 19 is another view of FIG. 11 in cross-section, without the conveyor;

FIG. 20 is another view of FIG. 16 in cross-section, without the conveyor;

FIG. 21 is another view of FIG. 16 in cross-section, without the conveyor;

FIG. 22 is another view of FIG. 19, with the carrier in a raised position to separate it from the bracket;

FIG. 23 is another view of FIG. 19, with the carrier in a raised position to separate it from the bracket;

FIG. 24 is a perspective view of a carrier frame;

FIG. 25 is a side view of the carrier frame of FIG. 24;

FIG. 26 is a front view of the carrier frame of FIG. 24;

FIG. 27 is a bottom view of the carrier frame of FIG. 24;

FIG. 28 is a side view of an article carrier including the carrier frame of FIG. 24 on a bracket;

FIG. 29 is another view of FIG. 28 in cross-section;

FIG. 30 is a perspective view of the article carrier of FIG. 28 with the carrier frame in a fully inclined forward tipped position;

FIG. 31 is a side view of the carrier of FIG. 30 in cross-section;

FIG. 32 is an other view of FIG. 31, but with the carrier frame at a partial forward inclination;

FIG. 33 is a front view of the article carrier of FIG. 28;

FIG. 34 is a front view of the article carrier of FIG. 28, with the carrier in a raised position to separate it from the bracket;

FIG. 35 is a perspective view of the article carrier as shown in FIG. 34;

FIG. 36 is a perspective view of the article carrier as shown in FIG. 33;

FIG. 37 is a side view of a tipping actuator having a trigger in a non-tipping position;

FIG. 38 is another side view of the tipping actuator of FIG. 37, but with the trigger in a tipping position;

FIG. 39 is a perspective view of FIG. 37;

FIG. 40 is side view showing the tipping actuator of FIG. 37 installed adjacent to a conveyor on which an article carrier is provided;

FIG. 41 is another view of FIG. 40, at a later period in time in which the trigger is disposed in a tipping position and the article carrier has moved nearer the trigger;

FIG. 42 is another view of FIG. 41, at a later period in time in which the article carrier has moved over part of the trigger, tipping the carrier frame of the article carrier into a side tipped position;

FIG. 43 is another view of FIG. 42, in perspective and at a later period in time in which the article carrier has moved further over the trigger, maintaining the side tipped position of the carrier frame

FIG. 44 is a perspective view of a roller for use with an article carrier;

FIG. 45 is a perspective view of a hub portion of the roller of FIG. 44;

FIG. 46 is a perspective view of an article contact portion of the roller of FIG. 44.

### DETAILED DESCRIPTION

Examples and/or embodiments will now be disclosed with reference to the drawings Figures. Like reference numerals are used for like features belonging to the article carrier, tipping actuator and conveyor system described and shown in the Figures.

The article carrier of the present invention may be used in a variety of areas for example weighing and distributing articles including, but not limited to, a variety of different fruits. Due to the variety of different articles and their associated variety of weights, there is an advantage of providing improvements to an article carrying device for use at least as part of a grading apparatus for articles of fruit within different sectors.

Referring to the drawings, an article carrier is shown generally referenced 1 which can receive an individual article to be graded or sorted. The nature or type of article may vary, and include, without limitation, a variety of different fruits or vegetables, for example kiwifruit, apples, berries, cherries.

The article carrier 1 has a bracket 2 which allows for the article carrier to be connected to a conveyor system 3 as part of a grading apparatus for a variety of articles, such as fruit. The article carrier 1 also has a carrier frame 4 which can be associated with the bracket 2 such that the two pieces can interact. Bracket 2 has legs 26 that have engagement or attachment means such as apertures 27 which allow the bracket to be attached to conveyor 3, for example by legs 26 straddling a part or segment, such as a chain link, of the conveyor 3.

The carrier frame 4 has a body which comprises a top surface 5 which in cooperation with roller(s) 10 receives and supports the articles carried by the carrier. The carrier frame 4 can also include an abutting or extending portion 6 which extends from the top surface 5 which can assist with forming support surfaces on which the fruit or other article can be carried in use. The carrier frame 4 also includes mounting points such as apertures 7, 8 on either side of the carrier frame 4 capable of receiving an axle 9 of a roller 10 such as a bowtie roller, or two separate rollers that are each formed as a frustum such that the outer surfaces of the roller(s) provide support surfaces that can act in concert with portions 5 and/or 6 to support the article to be carried. It will be understood that there may be a variety of numbers of bearing portions, and as such a variety of wheels, or similar, that may be used depending on the article that is to be carried by the article carrier 1.

The carrier frame 4 has a support leg 11 which extends from the upper structure of the carrier frame and is configured to rest on a bearing surface of the bracket as described further below. The support leg 11 can, as shown in FIG. 6, extend from the top surface 5 opposite the abutting portion 6. The leg 11 extends downwards from the top surface 5, preferably between the two wheels 10, or similar. The leg 11 can be an L-shaped portion or an inverted T-shaped portion such that it extends downwards from the top surface 5 before extending back underneath the abutting portion 6 to form the L-shape or inverted T-shape.

The leg 11 has a lower surface 50 that is provided on a foot portion or at least a lower portion of the leg 11 and that in a carrying position in use rests on bearing surface 52 of the bracket. As shown in the Figures, surface 52 may comprise a plurality of surfaces such as 52a and 52b. It can also be seen that surface 52 is contoured, for example in an arcuate manner such as being concave when viewed from above. The surface 50 may be convex or have rounded lateral edges when viewed from below, so that together the surfaces 50 and 52 provide a separable pivotal connection between the carrier frame and the bracket. The separability is achieved by the carrier frame being able to be lifted off the bracket to a required extent so that the article being carried can be weighed.

The leg 11 includes limit means that limit the extend of longitudinal axial movement of the carrier, or at least the leg 11, relative to the bracket. It will be understood that the limit means can take a variety of forms. In the examples illustrated the leg 11 can be configured with an abutment, for example comprising a projection or flange 12 and/or 13 that implements the limit means by abutting against a surface or surfaces of the bracket 2 to prevent further relative movement past a required relative position or orientation.

In some examples, one abutment 12 is provided on the back or trailing side of the leg 11 or the surface 50. The abutment is configured to abut surface 54 at the trailing end of surface 52. This can be achieved by forming the abutment such that the abutment 12 forms a projecting surface that extends below the bottom of the L-shape of the leg. The abutment 12 assists in firmly seating the leg 11 onto surface 52, in part by locating the leg relative to the surface 52 and in part by preventing leg 11 from sliding too far forward so that it projects too far beyond surface 58, or so that in sliding forward it jams and thus prevents the freedom of movement required for pivoting or weighing operations.

Furthermore, the surface 52 may be at a slight angle 90 e.g. 2 or 3 degrees to the horizontal as shown by line 92 in FIG. 20. This angle 90 can assist in seating the leg 11 against the bracket 2 and may be selected based on the relative position of the upright or foot sections of leg 11 to the remainder of the carrier frame and the location of the transverse axis about which pivoting may occur—for example pivoting about the connection of linking connector member 16 which can comprise a wire configured to pivotally connect to the carrier and be captured in mouth 70 so as to allow loose movement between the bracket and carrier so that they remain in proximity to each other but are also separable so that the carrier can be separated from the bracket in order to weigh an item being carried.

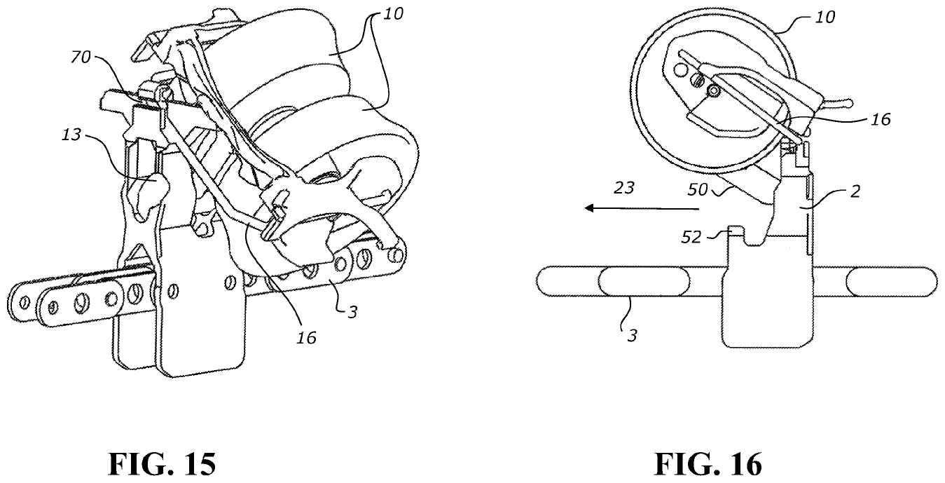

In some examples, another abutment 13 is alternatively or additionally on the other end of the L-shape or inverted T-shape of leg 11 and is configured so that it projects to contact a part of a front surface 58 of the backet when the carrier in angularly disposed to a tipping position about a longitudinal axis 60 (as shown in FIGS. 14 and 15). In an example abutment 13 extends upwards from the foot of the L-shape or inverted T-shape leg 11. As shown in FIGS. 14 and 15, the abutment 13 limits the extent to which the carrier frame can pivot upwards about a transverse axis (i.e. an axis directed into the page), as abutment 13 contacts inclined surface 18a. Pivotal movement of the carrier frame relative to the backet about a transverse axis is shown in FIG. 16.

The carrier frame 4 can have apertures 14, 15 on either side of the carrier frame 4 which can receive a connector member such as a wire 16, or similar, that extends from the outside of one side of the carrier frame 4 to the other side of the carrier frame 4 by passing underneath the abutting potion 6.

The bracket 2 can be associated with the carrier frame 4. The bracket 2 consists of an aperture 17 which can receive the engagement portion 11 of the carrier frame 4. The leg 11 can move within the bracket 2, such that the carrier frame 4 can move along a longitudinal axis as defined by the centre of the bracket 2. The carrier frame 4 can be moved away from the bracket, moving upward or pivotally having freedom determined by the connection of the wire 16 to the carrier frame such that the top surface 5 is angled as denoted by direction 23 and shown best on FIG. 16. The movement of the leg 11, and therefore the carrier frame 4, in the longitudinal axis is restricted by one or both of the two abutment portions 12, 13 of the leg 11 and the bracket 2.

The bracket 2 can be configured to comprise one or more internally angled surfaces 18 within the aperture 17 with which receives the engagement portion 11 such that as the carrier frame 4 is moved away from the bracket in the direction denoted by 23, the abutment 13 on the end of the L-shaped leg 11 may contact the internally angled surfaces 18 such that the leg will be guided to a central angular position, and will contact surface 18a stopping it from rotating in a tilting manner about the longitudinal axis to one side or the other.

Also, angled surface 18a may be provided to interact or co-operate with the abutment 13 to provide a seat against which the abutment can rest when the carrier is rotated about the transverse axis, so that further movement of the carrier frame 4 is restricted. It is to be understood that the selected angle to which the internally angled surface 18a is used will allow for more or less movement of the carrier frame in the longitudinal axis. Preferably, the internally angled surface 18 will be at an angle less than 90° such that the carrier frame 4 cannot move too far in the longitudinal axis, resulting in difficulties in returning to the un-moved position. As best seen in FIG. 18, the lip or abutment 12 on the L-shaped leg 11 is configured to contact the carrier frame 4 outside of the aperture 17 which receives the extension portion such that movement of the carrier frame 4 along the longitudinal axis in the opposite direction to that previously described, as denoted by direction 24 and shown on FIG. 18, is restricted when the top surface 5 is flat in a horizontal direction.

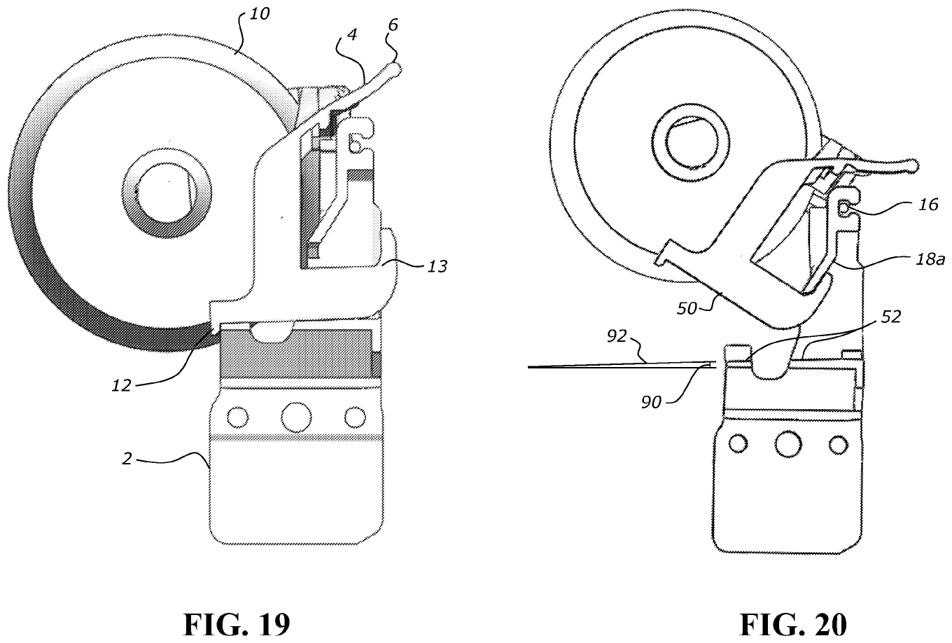

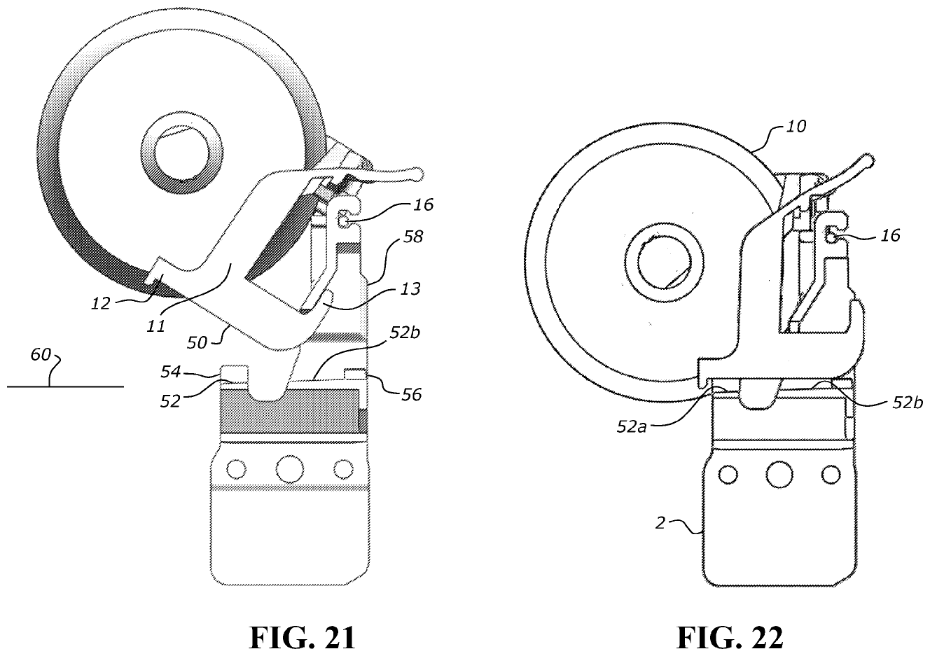

As is clear from FIGS. 18-23, this allows for the carrier frame 4 to reside in two positions, a first carrying position and a second extended position. The carrying position exists when the article carrier 1 is above the conveyor system 3 such that the top surface 5 is flat in a horizontal direction such that articles may be placed upon the top surface 5 and/or the wheel(s) 10, or similar, to be carried as such. During use while carrying an article, the lip or abutment 12 on the L-shaped leg 11 assists with keeping the top surface 5 flat due to restricting downwards movement in the longitudinal axis. The extended position can exist when the article carrier 1 is receiving fruit so that the fruit are singulated between adjacent carriers 1 for grading, and when the carrier is below the conveyor system 3. In this front tipped singulation position the movement of the carrier frame 4 is restricted by the abutment 13 on the end of the L-shaped engagement portion 11 as it contacts the internally angled surface 18.

The bracket 2 can also be shaped to receive the wire 16 such that the carrier frame 4 may pivot about this wire 16 in the longitudinal axis as disclosed above. The bracket 2, near the point in which the wire 16 is received, can be angled to have angled surfaces 19 such that the carrier frame 4 and hence the top surface 5 can also pivot in a transverse axis which exists transversely to the longitudinal axis and as denoted by direction 25. As shown best in FIG. 14, The angled surface 19 allows the wire 16 and the carrier frame 4 to pivot in the transverse direction while maintaining contact with the bracket 2. The bracket 2 also has a section 20 above which the wire 16 is received which restricts the movement of the wire 16 so as to stop the wire 16, and hence the carrier frame 4, from moving too far in the transverse direction. The bracket 2 can also comprise angled inner walls 21 of the aperture 17 which can receive the engagement portion 11 such that the engagement portion 11 will contact the angled inner walls 21 so as to stop the carrier frame 4, and hence the wire 16, from moving too far in the transverse direction as shown best in FIG. 14. It is to be understood that section 20 above which the wire is received and the angled inner walls 21 of the aperture 17 which can receive the engagement portion 11 can work in conjunction or separately to stop either the engagement portion 11, the wire 16, or both from moving too far in the transverse direction. As is shown in FIG. 14 and as disclosed above, there exists a third position in which the carrier frame 4 and hence the top surface 5 are angled in this transverse direction to eject the article from the article carrier 1 as required during the grading system.

The carrier is easily connected from the backet 2 as the wire 16 is received in cavity 72 by pushing it through opening or mouth 70. The lips or jaws 74 and 75 are configured to present an opening which is slightly smaller than the width of the wire 16, and the material from which the bracket is constructed can allow one or both of the jaws to move slightly in a resilient manner, for example by bending, so that the wire 16 cannot escape in normal intended use but can be pulled from or pushed into the cavity 72 when sufficient force is applied.

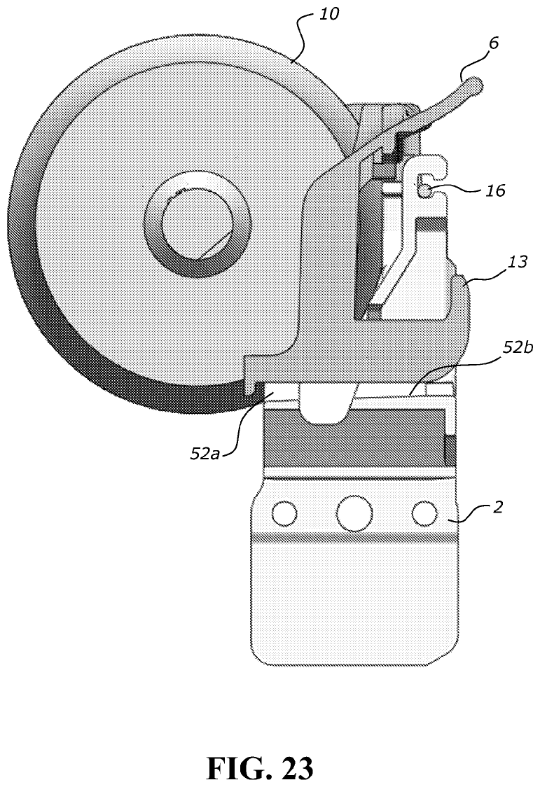

The section 20 of the bracket 2 which is above which the wire 16 is received can also act to work independently such that the carrier frame 4 is lifted to have no contact with the bracket 2, as shown in FIGS. 22 and 23.

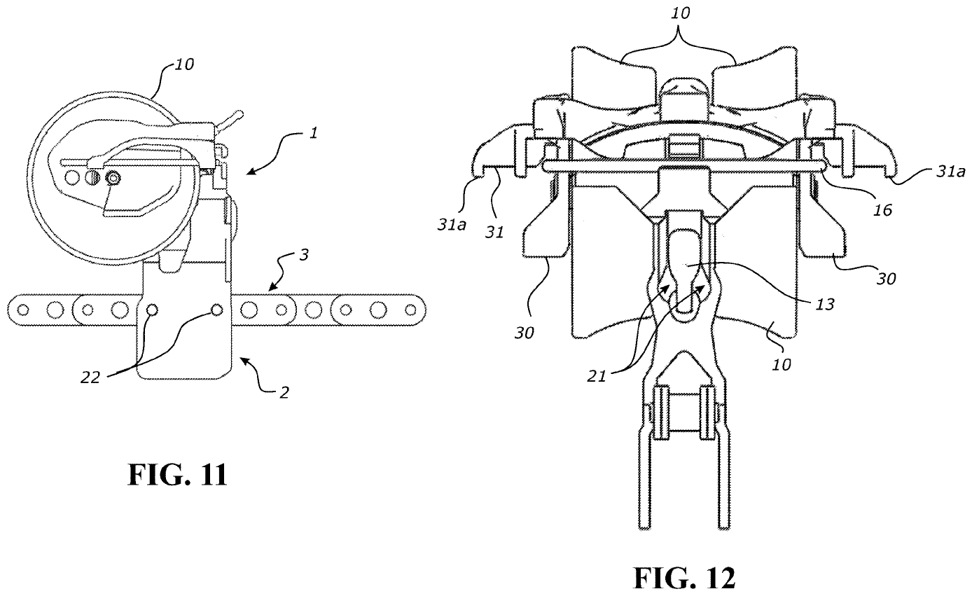

The bracket 2 can further include a variety of apertures 22 of other openings with which allow for the bracket 2 to be attached to the conveying system 3. The apertures 22 can be those as shown in FIG. 11, for example.

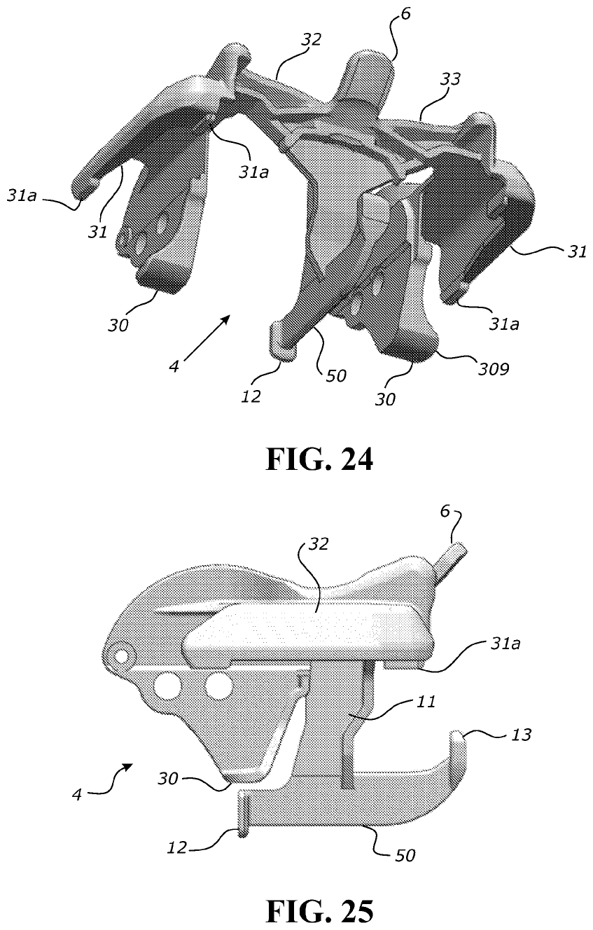

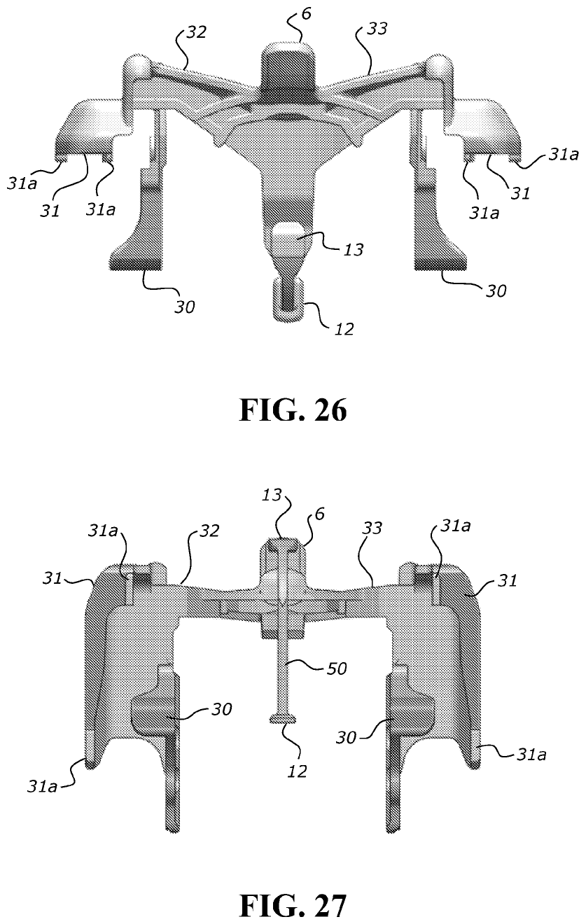

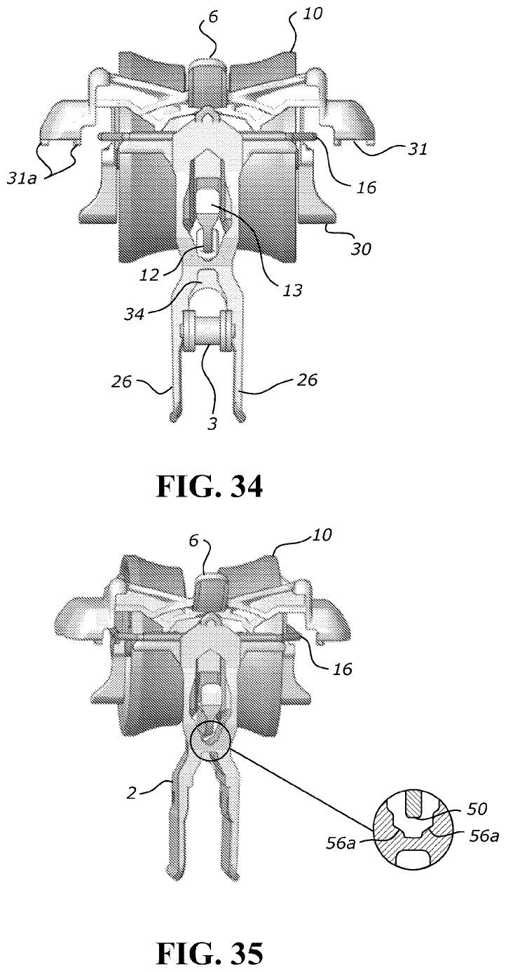

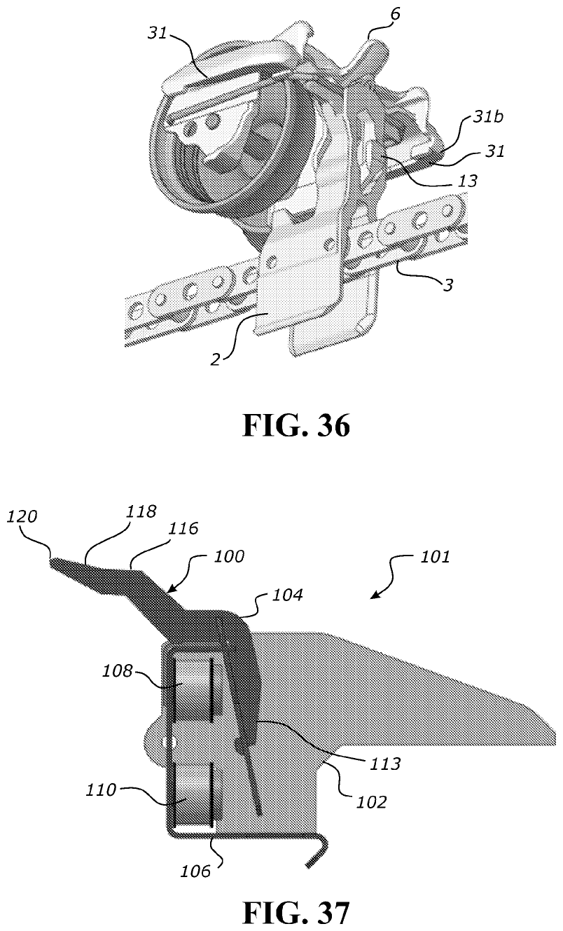

Carrier frame 4 has wings or arms 32 and 33 that extend either side of portion 11, and either side of bracket 2 when backet 2 is connected to the carrier frame. As can be seen from FIG. 24, arms 32 and 33 each provide tipping surfaces 31 and 30. Each surface 30 and 31 is configured to provide a tipping contact surface. Surfaces 31a comprise weigh surfaces, being contact surfaces, which weighing apparatus contacts to lift frame 4 so that the weight of the carried item and frame 4 is supported independently of the remainder of the apparatus, so that the weight of the carried item can be determined. The weighing position can be seen in FIGS. 22, 23 and 35 for example. The tipping surface 31 is located above the weigh surface 31a. As can be seen from the Figures (e.g., FIGS. 26 and 34), weigh surface(s) 31a can be located to one or both sides of the surface 31. It can also be seen that the weigh surface(s) 31a can be located to one or both ends of the surface 31. The tipping surface 31 may extend from an outer edge of the roller 10 to the axis of rotation 9a of the roller, as shown in the Figures (for example FIG. 36).

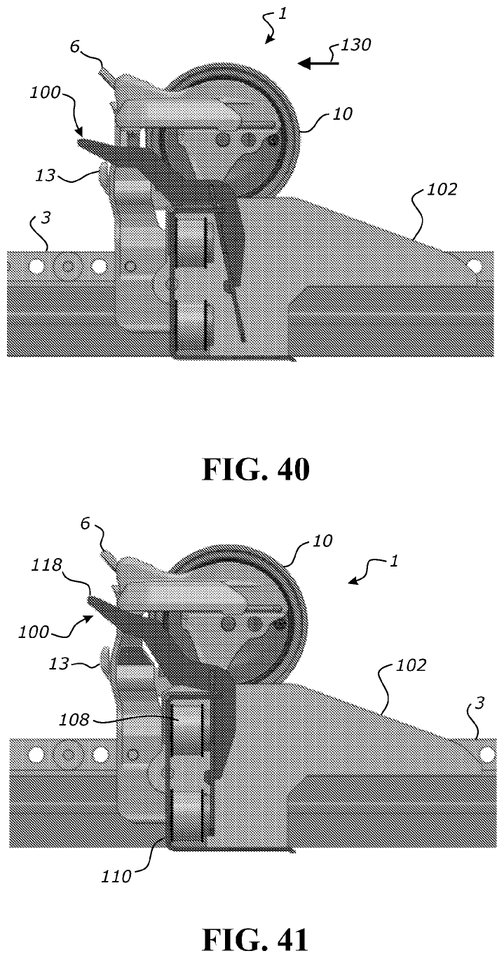

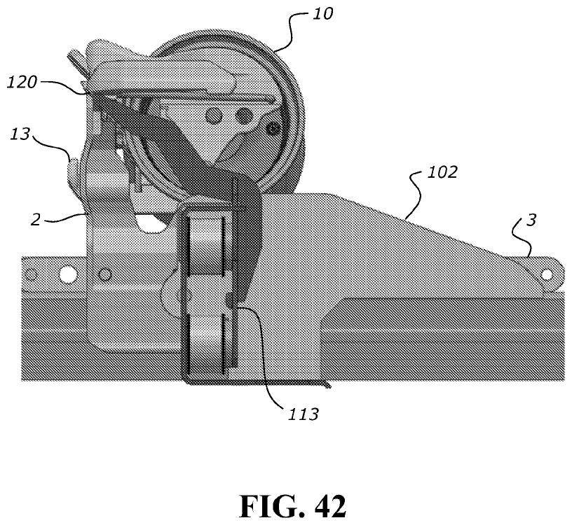

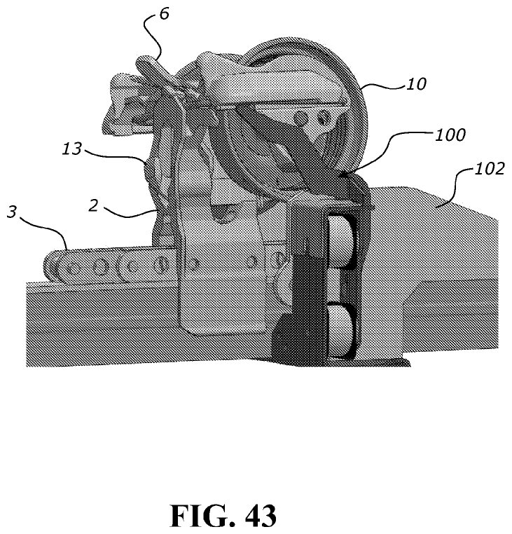

The tipping contact surface 31 is selectively contacted in use by an actuator or trigger member 102, an example of which can be seen in FIGS. 34-40. As described further below, tipping in the sense of surface 31 comprises a side tipping surface configured to tip the carrier frame to one side i.e., transversely. This transverse tipping action occurs by pivotal or rotational movement about the longitudinal axis generally indicated 51 or 60 defined by surfaces 50 and 52 about which the carrier 4 rotates relative to the bracket 2. The tipping action is performed in use to allow an article carried by the apparatus to be offloaded at a selected location while the carrier 1 is moving on the conveyor.

The surface 31 is provided distally of the longitudinal axis generally indicated 51 defined by surfaces 50 and 52 about which the carrier 4 rotates relative to the bracket 2. This provides a longer lever arm for a force applied by trigger 102 to have effect. Distance of surface 31 from the axis 51 is achieved by increasing or maximizing the distance of surface 31 from axis 51 in one or both horizontal and vertical directions. Therefore, side tipping surface 31 can be located as high as practicable, for example at or above the axis 9a of axle 9 of the roller 10. Surface 31 can be located so that it is provided transversely (i.e. in a direction extending parallel to axis 9a of the roller) beyond the roller 10. Surface 31 can be located so that it is above weigh surface 31a.

Tipping contact surface 30 comprises a front tipping surface configured to tip the carrier frame forward in a longitudinal direction to receive or offload an article from the front of the carrier, as shown in FIG. 16. This longitudinally directed tipping action occurs by pivotal or rotational movement about the contacting regions 34 (of the bracket 2) and 35 (of the carrier 4). The axis about which this pivotal or rotational movement occurs is thus transverse to the direction of travel.

The tipping contact surface 30 is provided distally from the contacting surface regions 34 and 35 which cooperate to provide an axis about which the pivotal or rotational movement occurs. This provides a longer lever arm for a force applied a trigger to have effect. Distance of surface 30 from the axis is achieved by increasing or maximizing the distance of surface 30 from the axis in at least a vertical direction. Therefore, front tipping surface 30 can be located as low as practicable, for example being provided at or below the axis 9a of axle 9 of the roller 10. Surface 30 may be located below axis 9a and above axis 51. Surface 30 can be located so that it is provided transversely (i.e., in a direction extending parallel to axis 9a of the roller) beyond the roller 10. Surface 30 can be located so that it is provided rearwardly of surfaces 5 and/or 6. Surface 30 can be located so that it is provided between surface 5 and/or 6 and axis 9a. Surface 30 can be located so that it is provided vertically below and horizontally adjacent to axis 9a. Surface 30, as shown in the Figures, for example FIGS. 24 and 26, has a leading edge configured to provide an inclined contour 30a. The inclined contour 30a may comprise a curve. Contour 30 may be configured to cooperate with a trigger member to initiate a required tipping action.

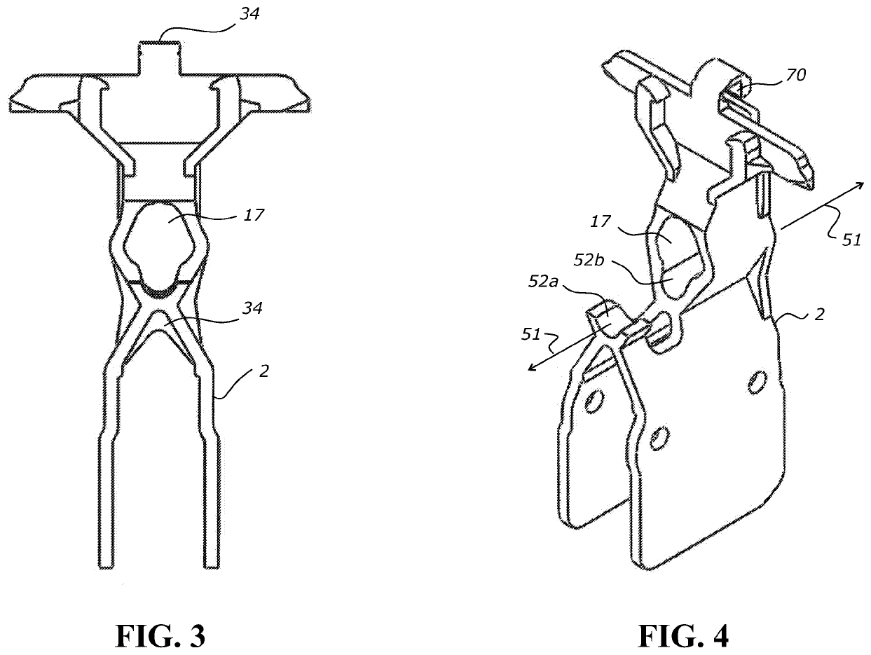

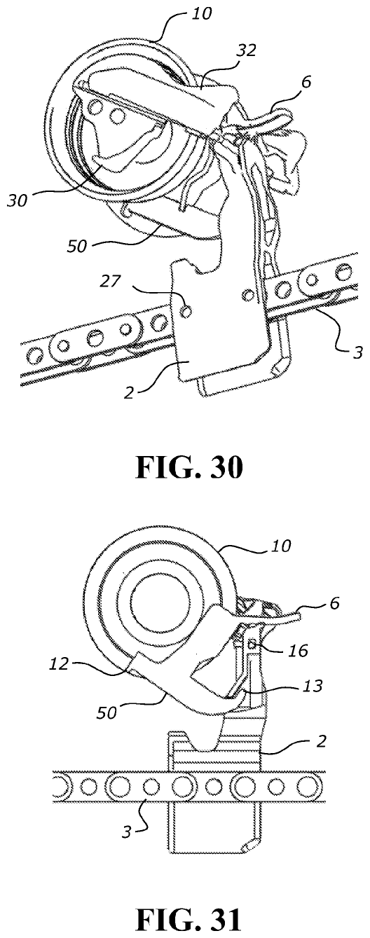

A web member 34 may be provided which spans proximal end regions (i.e. nearest the body of the bracket) of the legs 26 of bracket 2 adjacent to the region in which legs 26 join the body of carrier 2, as shown for example in FIGS. 3, 30 and 31. The web member 34 extends between proximal regions of each leg to provide a structural link or connection between legs 26 and bracket 2 and is configured to enhance a resilient bias of legs 26 to maintain engagement with the section or link of conveyer 3 to which the bracket is connected. In use, legs 26 are pulled apart to allow the conveyor link to be received between them until openings 22 receive corresponding projecting regions of the conveyor. Therefore, legs 26 are resilient, for example being moulded from a plastics material, and are configured to hinge slightly relative to the body of bracket 2, and web member 34 provides a biassing action to return and maintain legs 26 in an engagement position with the conveyor 3. The web member 34 may be connected to the body, or be separate from the body, of the bracket 2. The web member can be proved at a rear end of the bracket, for example being located beneath surface 52a. In this position the web member may provide more support as the remainder of the body of bracket 2 is located adjacent surface 52b.

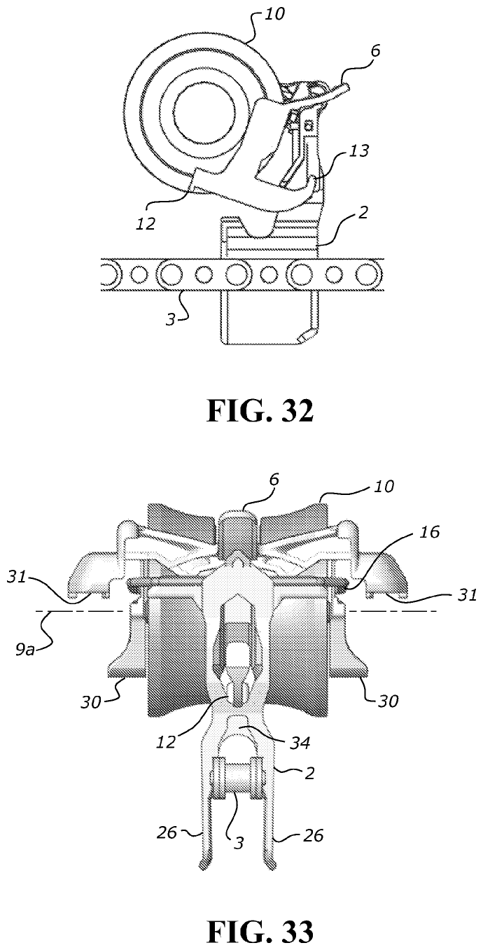

The bearing surface 50 and the support surface 52 can be complementarily contoured to centre the support leg relative to the bracket. The contours can also assist in biassing the carrier 4 in a non-tipping position for example to assist in returning the carrier 4 to the non-tipping position. As shown in FIG. 32, a part of surface 52, for example surface 52a can include a contour 56 such as a recess which in FIG. 32 is shown defined by shoulders 56a. The recess can instead be located in the surface 52. Recess 56 can be shaped or configured to conform to a part of surface 50 so that it receives a part of surface 50 to thereby locate and/or stabilise member 11, and thus the carrier 4, in a carrying i.e., non-tipping position relative to the bracket 2. Recess or contour 56 can have a base (i.e., lower-most surface, with walls that are angled to slope upwardly to shoulders 56a. This facilitates the carrier frame 4 settling under gravity into the recess. Recess or contour 56 is configured to allow the carrier to move to a tipping position in response to forces applied to tipping surfaces 30 or 31 as described above. Alternatively, or additionally, surfaces 34 and 35 may be complimentarily contoured or shaped to locate and/or stabilise the carrier 4 in a carrying position relative to the bracket 2.

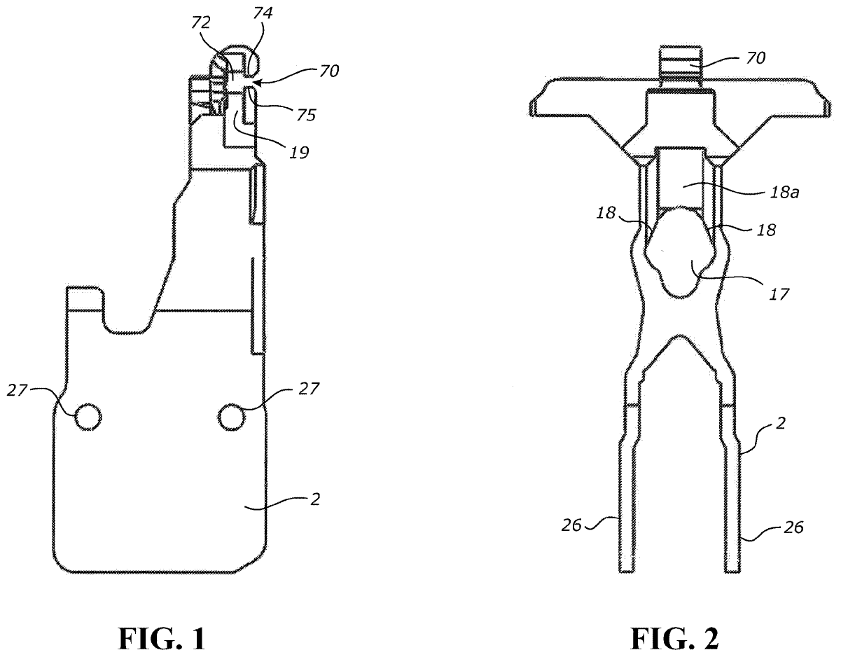

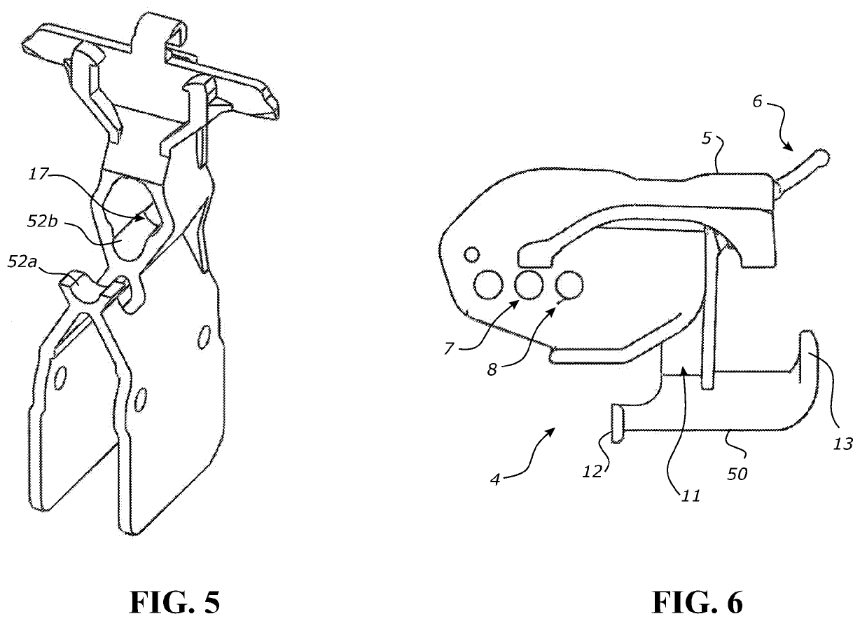

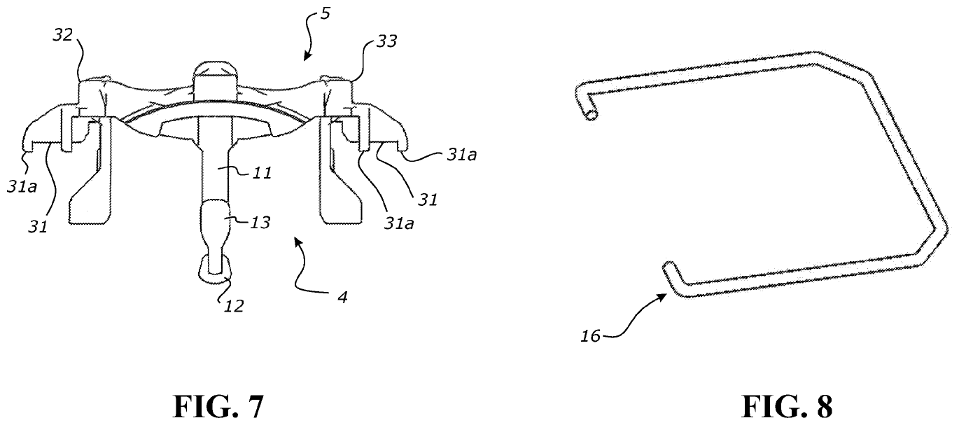

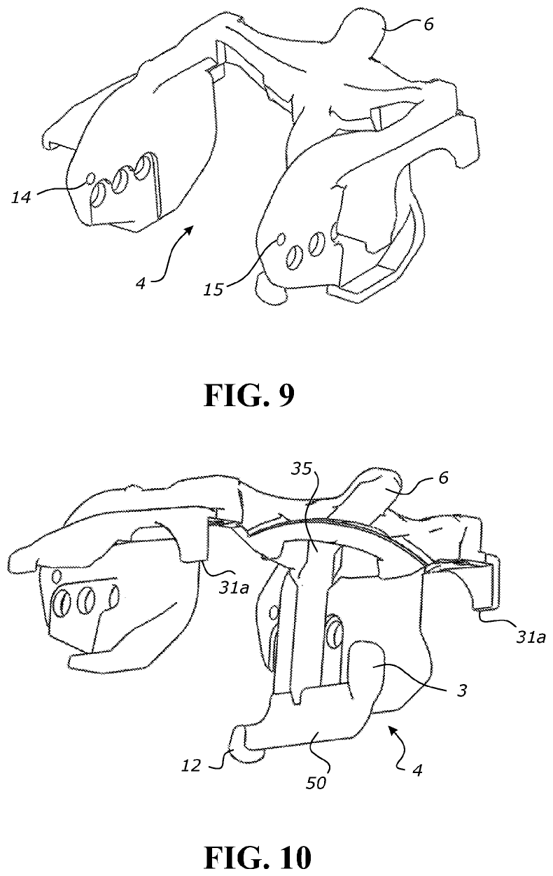

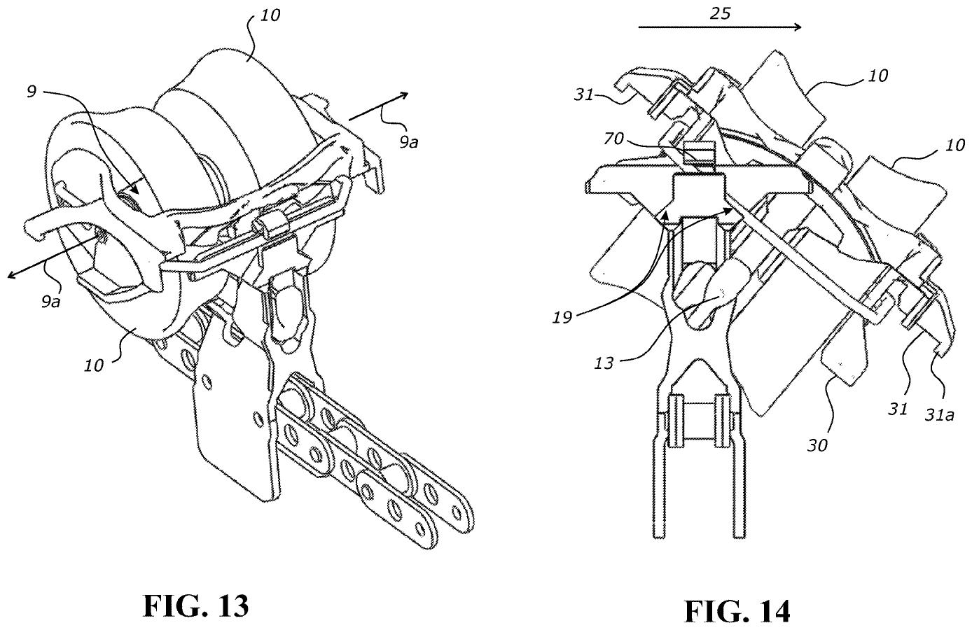

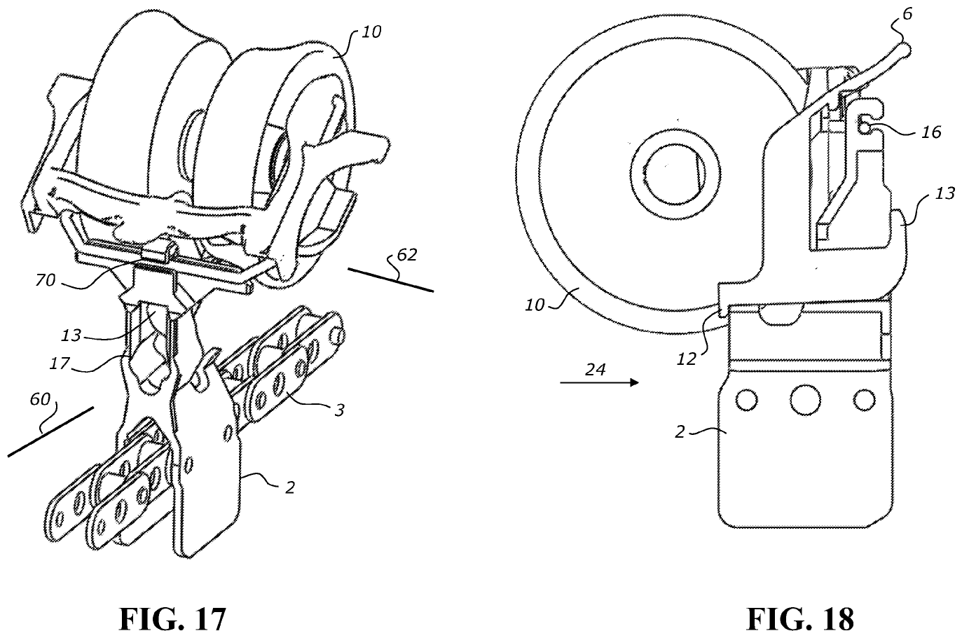

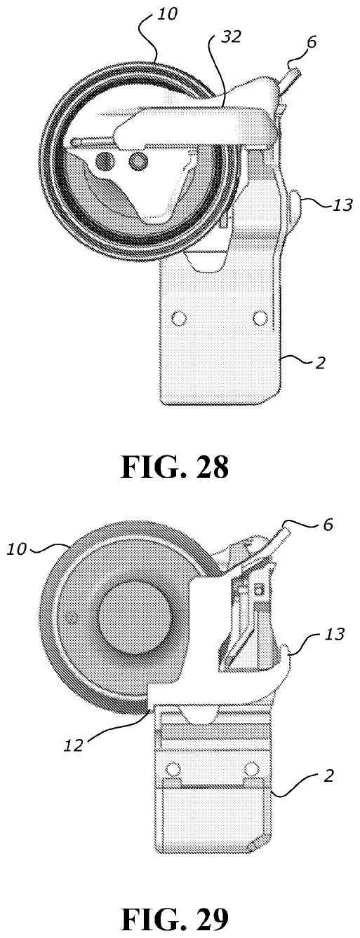

FIGS. 34-40 illustrate a tipping actuator 101 that may be used with the article carrier 1 disclosed herein. Although the actuator 101 is shown in FIGS. 37-40 as being used with the carrier 1 as described with reference to FIGS. 24-33, it can be used with the carrier 1 described with reference to FIGS. 1-23. The actuator 101 includes a frame or housing comprising members 102 and 106 which are configured to mount or carry actuators 108 and 110 which in this example comprise solenoid actuators having a coil that is selectively electrically energisable to attract or repel a magnetically susceptible object (e.g., a magnet or suitable metal). Trigger 100 is pivotally connected to the frame by a pivot connection 104. The trigger 100 is disposed in a non-tipping position in FIG. 34 in which arm 113 is distal (i.e., separated or angled away from actuator 108 and/or 110. In the non-tipping or rest position tipping surface contacting regions 118 and 120 are disposed in a lowered position.

Trigger 100 may be biased in the non-tipping position. This may occur using a spring for example or configuring the centre of mass of the trigger relative to the pivot point leaving the trigger in the non-tipping position, or operating one or more actuators 108, 110 to force (by repelling arm 113) trigger 100 into the non-tipping position.

Trigger 100 is moved to the tipping position as shown in FIG. 35 by operating actuators 108, 110 to pull the arm 113 toward them. Arm 113 may include one or more magnets 112 and 114, for example, on which a magnetic field provided by the actuators can act. Both actuators 108 and 110 can be actuated at the same time, or one can be activated before the other, for example 108 being energised ahead of 110. Having a first actuator such as 108 nearer the pivot point 104 allows that actuator to be located near the arm 113 when the trigger is in the non-tipping position. This allows the actuator to exert more force on arm 113, or at least on a portion of arm 113 adjacent to the location of the pivot 104, to initiate movement of arm 113 toward the actuator(s) so that trigger 100 moves to the tipping position.

Having an actuator such as 110 which is provided further from pivot 104 allows that actuator to exert a force on arm 113 at a greater distance from the pivot 104 and thus exerts additional torque as the arm 113 moves toward the actuator to bring the trigger into the tipping position. Once arm 113 is in contact with, or adjacent to, the actuator 110, actuator 110 assists with locking the trigger 100 in the tipping position by means of the lever created by its distal position from pivot 104.

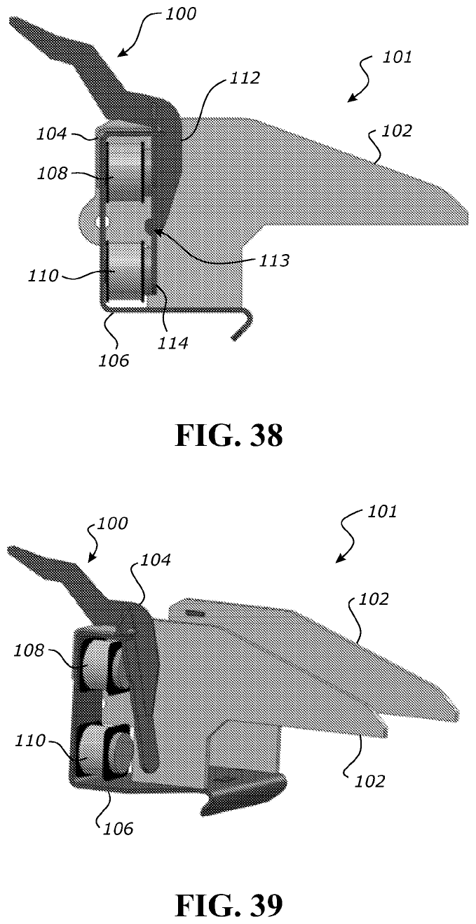

Referring to FIG. 37, the actuator 101 is shown mounted stationary adjacent to conveyor 3. The trigger 100 is shown in the non-tipping position as a carrier 1 approaches in the direction shown by arrow 130. The trigger 100 is moved to the tipping position in FIG. 38, just prior to the carrier frame 4 arriving, so that it is ready to contact side tipping surface 31.

As can be seen in FIG. 39, one or both of inclined surfaces 116 and/or 118 contact a leading edge 31b of the side tipping surface 31 to guide the arm 33 (in this example) upward so that the carrier frame 4 pivots relative to the bracket 2 about a longitudinal axis as described above. Separate surfaces 116 and 118 may not always be required. For example, a single inclined surface can be provided. Providing multiple surfaces 116/118 allows different angles or contours to be provided so that the rate and/or extent of rotation about the axis 51 can be varied or controlled relative to the position of the leading edge 31b. this can allow a required tipping profile to be provided. For example, if surfaces 116 and 118 are provided, surface 116 can have a smaller angle relative to surface 31 than the angle of surface 118 relative to surface 31. Therefore, initiation of rotation of the arm 33 about axis 51 can begin at a low angular velocity to begin a gradual tipping action and then accelerate once edge 31b contacts surface 118.

The leading edge 31 progresses along inclined surface 116/118 until reaching surface 120. Surface 120 does not have to be provided for some applications. If surface 120 can be configured to be substantially horizontal. Surface 120 contacts surface 31 to allow trigger 100 to maintain the carrier frame 4 in the tipping position until then distal end of surface 31 (i.e., the end that is longitudinally remote from leading edge 31b) has passed surface 120. The carrier frame 4 then rotates back under gravity about axis 51 to return to the carrying (i.e., non-tipping) position.

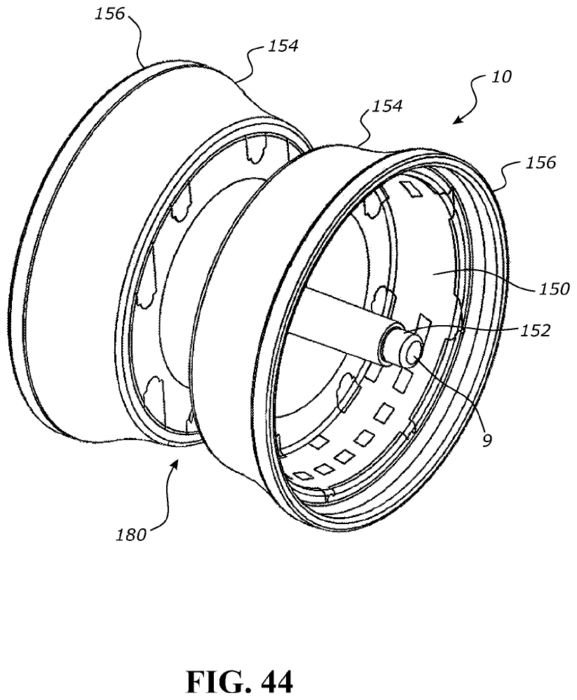

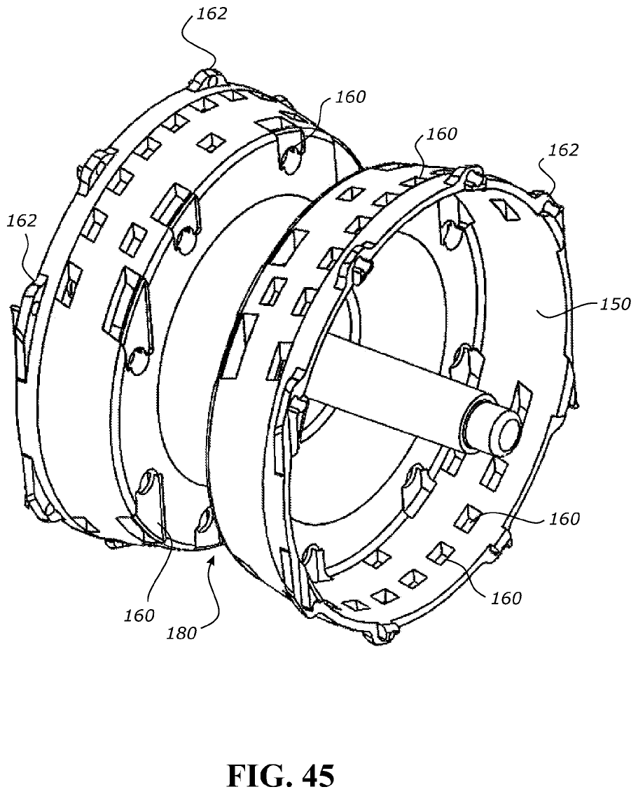

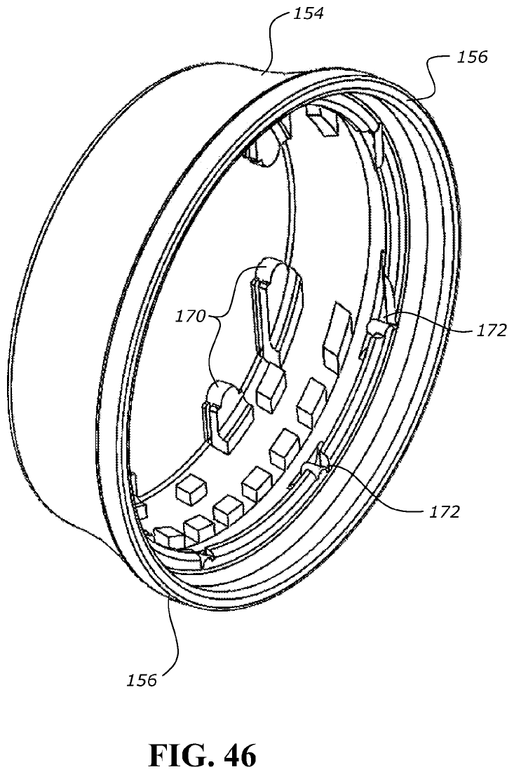

Turning now to FIGS. 44-46, a roller 10 is shown, which may be used with any one or more of the carriers or carrier systems disclosed herein. Roller 10 has a hub portion 150 configured to provide (for example provide a bearing surface 152) or receive an axle (for example having an aperture for engaging with an axle), the hub portion 150 comprising a first material having a first hardness. The hub portion may be made from a rigid plastics material. An article contact portion 154 is engaged with the hub portion 150, the article contact portion 154 being configured to at least partially support an article, such as an item of fruit. The article contact portion is constructed from a second material which has a second hardness which is less hard than the material from which the hub 150 is made i.e., it is softer. The second material may be a reliant material or a rubber-like material. As can be seen, the article contact portion allows articles such as fruit that are to be at least partially supported by the roller to encounter a relatively soft or resilient surface, and therefore prevent the fruit from bruising. This structure also has the advantage that the hard material can be configured to structurally support the roller relative t an axle and also provide structural support where required for the cushioning material which is contoured and configured to receive and/or support the article to be carried.

The article contact portion 154 may comprise a flange 156 that protrudes beyond a periphery of the hub portion. The flange can protrude in a direction parallel to an axial axis of the axle or optionally the flange protrudes radially, or optionally both axially and radially. The flange is located at an external edge of the roller and is thus the part of the roller that is most likely to present a surface capable of damaging fruit. Having the flange 156 provided from a soft or rubber-like material leaves the soft material overhung at the rim, unsupported by the hard material of the hub, ensuring that the soft material shape is controlled but flexible enough to delicately cushion the fruit when transferred on and off the roller.

The hub portion 150 comprises a plurality of recesses and/or apertures 160 configured to receive corresponding portions 170 of the article contact portion. Alternatively, or optionally, protrusions 162 can be provided which are received in 172. In an embodiment the article contact portion is overmoulded about at least a portion of the hub, so that the recesses and protrusions of the hub are configured to provide a mechanical connection between the hub and the article contact portion.

The engagement between the hub portion and the article contact portion is configured to prevent any gap between the portions that is sufficiently large to present a hygiene hazard for sorting or grading fruit.

In an embodiment the roller has two article contact portions connected to a hub portion. In an embodiment the roller may comprise two joined hub portions, each with an article contact portion. The article contact portions can be provided axially side by side and optionally next to each other separated by a groove or by a gap.

In an embodiment the two article contact portions are configured to slope toward each other. The configuration allows an article to naturally centre itself at a required position on the roller. The roller can comprise a bowtie roller.

It will be seen that the roller can be manufactured from two plastic materials of different properties that are connected in a way that physically makes them one part therefore the interface connections cannot harbour bacteria. ensuring the roller is naturally hygienic and easy to clean. Additionally, it can be seen that the design facilitates minimizing the amount of soft more expensive material that is in contact with the fruit, because the harder cheaper material supports the soft material.

### CLAUSES

1. An article carrier, comprising:
a bracket configured for attaching the article carrier to a conveyor, the bracket having a longitudinal axis and a carrier frame support surface;
a carrier frame configured to support an article, the carrier frame having a support leg comprising a bearing surface configured to co-operate with the carrier frame support surface whereby the carrier frame is separably pivotally supported by the bracket such that the carrier frame is able to pivot relative to the bracket about the longitudinal axis, and wherein:
   the support leg further comprises a limit means to limit longitudinal movement of the carrier relative to the bracket.

2. The carrier of clause 1 wherein the limit means comprises at least one abutment portion on the support leg.

3. The carrier of clause 1 or 2 wherein the limit means is configured to limit longitudinal movement of the carrier relative to the bracket while the carrier frame pivots about the longitudinal axis.

4. The carrier of any one of the preceding clauses wherein the limit means is located on a leading end of the support leg.

5. The carrier of any one of clauses 1 to 3 wherein the limit means is located on a trailing end of the support leg.

6. An article carrier, comprising:
a bracket configured for attaching the article carrier to a conveyor, the bracket having a longitudinal axis and a carrier frame support surface;
a carrier frame configured to support an article, the carrier frame having a support leg comprising a bearing surface configured to co-operate with the carrier frame support surface whereby the carrier frame is separably pivotally supported by the bracket such that the carrier frame is able to pivot relative to the bracket about the longitudinal axis, and wherein:
   the carrier frame support surface is provided at an inclined angle in use such that it rises from a trailing end to a leading end.

7. The article carrier of clause 6 wherein the carrier frame further comprises a lip configured to abut the trailing end of the carrier frame support surface.

8. An article carrier, comprising:
a bracket configured for attaching the article carrier to a conveyor, the bracket having a longitudinal axis and a carrier frame support surface;
a carrier frame configured to support an article, the carrier frame having a connector member which connects the carrier frame to the bracket such that the carrier frame is able to pivot relative to the bracket about the longitudinal axis, and wherein:
   the bracket comprises a cavity configured to receive part of the connector member, and the cavity having a mouth configured to allow the part of the connector member to enter or exit the cavity.

9. The article carrier of clause 8 wherein the mouth is defined by jaws and one of the jaws is configured to move to allow the connector member to enter or exit the cavity.

10. An article carrier, comprising:
a bracket configured for attaching the article carrier to a conveyor;
a carrier frame configured to support an article;
a pivot means configured such that a carrier frame is able to pivot relative to the bracket along a longitudinal axis of the bracket and along a transverse axis that extends transversely to the longitudinal axis, wherein:
the carrier frame comprises an abutting portion configured to prevent longitudinal movement while the carrier frame pivots about the longitudinal axis.

11. An article carrier, comprising:
a bracket configured for attaching the article carrier to a conveyor;
a carrier frame configured to support an article;
a pivot means configured such that a carrier frame is able to pivot relative to the bracket along a longitudinal axis of the bracket, wherein:
the carrier frame comprises an abutting portion configured to prevent longitudinal movement in one longitudinal direction.

12. An article carrier, comprising:
a bracket configured for attaching the article carrier to a conveyor;
a carrier frame configured to support an article;
a pivot means such that a carrier frame is able to pivot along a longitudinal axis of the bracket and along a transverse axis that extends transversely to the longitudinal axis, wherein the bracket comprises a surface configured to contact a corresponding surface of the article carrier to prevent further movement of the carrier frame about the transverse axis.

13. An article carrier, comprising:
a bracket configured for attaching the article carrier to a conveyor, the bracket having a longitudinal axis and a carrier frame support surface;
a carrier frame configured to support an article, the carrier frame having a support leg comprising a bearing surface configured to co-operate with the carrier frame support surface whereby the carrier frame is separably pivotally supported by the bracket such that the carrier frame is able to pivot relative to the bracket about the longitudinal axis to a tipping position, and wherein:
   the bearing surface and the support surface are complementarily contoured to centre the support leg relative to the bracket and/or to bias the carrier to a carrying or non-tipping position.

14. The article carrier of clause 13 wherein one of the bearing surface or support surface comprises a recess contoured to bias the carrier to a carrying position.

15. The article carrier of clause 14 wherein a shoulder is provided either side of the recess.

16. The article carrier of clause 13 or 14 wherein the recess comprises a base and an angled wall either side of the base.

17. An article carrier, comprising:
a bracket configured for attaching the article carrier to a conveyor, the bracket having a longitudinal axis and a carrier frame support surface;
a carrier frame having a roller configured to support an article, a bearing surface configured to co-operate with the carrier frame support surface whereby the carrier frame is separably pivotally supported by the bracket such that the carrier frame is able to pivot relative to the bracket about the longitudinal axis, and a tipping surface configured to contact an actuator to tip the carrier frame about the longitudinal axis, wherein the tipping surface is located at or above a weighing surface.

18. An article carrier, comprising:
a bracket configured for attaching the article carrier to a conveyor, the bracket having a longitudinal axis and a carrier frame support surface;
a carrier frame having a roller configured to support an article, a bracket support surface configured to co-operate with the carrier frame support surface whereby the carrier frame is separably pivotally supported by the bracket such that the carrier frame is able to pivot relative to the bracket about a transverse axis which is transverse to the longitudinal axis, a front tipping surface configured to contact an actuator to tip the carrier frame about the transverse axis, a side tipping surface configured to contact an actuator to tip the carrier frame about a longitudinal axis, and wherein the front tipping surface is located below the side tipping surface.

19. An article carrier according to any one or more of the preceding clauses.

20. An article carrier bracket, comprising:
a body including a support means for supporting a carrier frame, two resilient legs extending from the body, each leg having a proximal end proximate to the body and a distal end remote from the body, the legs being separated from each other whereby the distal ends define an opening for receiving a part of a conveyor, each leg including an engagement formation for engaging with the conveyor part, and a web member extending from the proximal end of one leg to the proximal end of the other leg, the web member being configured to provide a structural connection between the proximal ends of the legs.

21. The article carrier according to clause 19 wherein the bracket comprises a bracket according to clause 20.

22. A tipping actuator for a conveyor system, the tipping actuator comprising:
a frame;
a trigger member pivotally mounted on the frame by a pivot connection and moveable between a non-triggering position and a triggering position;
a plurality of actuators, the actuators being energisable to move the trigger member to the non-triggering position or the triggering position, wherein one actuator is mounted closer to the pivot than the other.

23. The tipping actuator of clause 22 wherein the trigger comprises a carrier contacting surface and the trigger is configured to rotate upwardly into the triggering position whereby the carrier contacting surface is oriented to contact an article carrier to thereby tip the carrier.

24. The tipping actuator of clause 22 or clause 23 wherein the carrier contacting surface is provided on one side of the pivot connection and an arm is provided on the other side of the pivot connection.

25. The tipping actuator of clause 22 wherein the actuators act on the arm to move the trigger member to the non-triggering position or triggering position.

26. An article carrier system or a conveyor system comprising one or more article carriers according to clause 19 or clause 21 and one or more tipping actuators according to any of clauses 22-25.

27. An article grading or sorting roller comprising:
a hub portion configured to provide or receive an axle, the hub portion comprising a first material having a first hardness;
an article contact portion engaged with the hub portion, the article contact portion being configured to at least partially support an article, and comprising a second material having a second hardness, and
wherein the second hardness is less than the first hardness.

28. The roller of clause 27 wherein the article contact portion comprises a flange that protrudes beyond a periphery of the hub portion.

29. The roller of clause 28 wherein the flange protrudes in a direction parallel to an axial axis of the axle or optionally the flange protrudes radially, or optionally both axially and radially.

30. The roller of any of clauses 27 to 29 wherein the hub portion comprises a plurality of recesses and/or apertures configured to receive corresponding portions of the article contact portion.

31. The roller of any of clauses 27 to 30 wherein the second material is configured to prevent bruising of fruit to be carried in use by the roller.

32. The roller of any of clauses 27 to 31 wherein the second material comprises a resilient material.

33. The roller of any of clauses 27 to 32 wherein the second material comprises a rubber-like material.

34. The roller of any of clauses 27 to 33 wherein the article contact portion is overmoulded on the hub portion.

35. The roller of any of clauses 27 to 34 configured to carry fruit, and wherein the engagement between the hub portion and the article contact portion is configured to prevent any gap between the portions that is sufficiently large to present a hygiene hazard for sorting or grading fruit.

36. The roller of any of clauses 27 to 35 comprising two roller portions provided axially side by side and optionally next to each other separated by a groove or by a gap.

37. The roller of clause 36 wherein the two roller portions are configured to slope toward each other.

38. The roller of any of clauses 27 to 37 comprising a bowtie roller.

39. An article carrier or grading system according to any of clauses 1 to 26 having a roller according to any of clauses 27 to 38.

40. A method of constructing an article grading or sorting roller comprising:
forming a hub portion configured to provide or receive an axle, the hub portion comprising a first material having a first hardness;
overmoulding an article contact portion about at least a part of the hub portion, the roller portion being configured to at least partially support an article, and comprising a second material having a second hardness, and wherein the second hardness is less than the first hardness.

41. An article carrier or grading system according to any of clauses 1 to 26 having a roller formed according to clause 40.

1. An article carrier, comprising:
a bracket configured for attaching the article carrier to a conveyor, the bracket having a longitudinal axis and a carrier frame support surface;
a carrier frame having a roller configured to support an article, a bearing surface configured to co-operate with the carrier frame support surface whereby the carrier frame is separably pivotally supported by the bracket such that the carrier frame is able to pivot relative to the bracket about the longitudinal axis, and a tipping surface configured to contact an actuator to tip the carrier frame about the longitudinal axis, wherein the tipping surface is located at or above at least one or a weighing surface and an axis of the roller.

2. The article carrier of claim 1 wherein the tipping surface is located at or above at the weighing surface.

3. The article carrier of claim 1 or claim 2 wherein the weighing surface is provided to one or both sides of the tipping surface.

4. The article carrier of any of the preceding claims wherein the weighing surface is provided to one or both sides of the tipping surface.

5. The article carrier of any of the preceding claims wherein the tipping surface extends longitudinally from an edge of the roller to the axis of the roller.

6. The article carrier of any of the preceding claims wherein the carrier frame comprises a further tipping surface configured to contact an actuator to tip the carrier frame about a transverse axis, the further tipping surface being located below at least one of the tipping surface and the axis of the roller.

7. The article carrier of any of the preceding claims wherein the carrier frame includes a support leg comprising the bearing surface and wherein the support leg further comprises a limit means to limit longitudinal movement of the carrier relative to the bracket.

8. The article carrier of claim 7 wherein the limit means comprises at least one abutment portion on the support leg.

9. The article carrier of claim 7 or 8 wherein the limit means is configured to limit longitudinal movement of the carrier relative to the bracket while the carrier frame pivots about the longitudinal axis.

10. The article carrier of any of claims 7 to 9 wherein the limit means is located on a leading end of the support leg.

11. The article carrier of any of claims 7 to 9 wherein the limit means is located on a trailing end of the support leg.

12. The article carrier of any of the preceding wherein the carrier frame support surface is provided at an inclined angle in use such that it rises from a trailing end to a leading end.

13. The article carrier of claim 12 wherein the carrier frame further comprises a lip configured to abut the trailing end of the carrier frame support surface.

14. The article carrier of any of the preceding claims wherein the carrier frame is able to pivot about a transverse axis that extends transversely to the longitudinal axis, wherein the bracket comprises a surface configured to contact a corresponding surface of the article carrier to prevent further movement of the carrier frame about the transverse axis.

15. The article carrier of any of the preceding claims wherein the bearing surface and the support surface are complementarily contoured to centre the support leg relative to the bracket and/or to bias the carrier to a carrying or non-tipping position.

16. The article carrier of claim 15 wherein one of the bearing surface or support surface comprises a recess contoured to bias the carrier to a carrying position.

17. The article carrier of claim 16 wherein a shoulder is provided either side of the recess.

18. The article carrier of claim 15 or 16 wherein the recess comprises a base and an angled wall either side of the base.

19. The article carrier of any of the preceding claims wherein the bracket comprises:
a body including a support means for supporting the carrier frame, two resilient legs extending from the body, each leg having a proximal end proximate to the body and a distal end remote from the body, the legs being separated from each other whereby the distal ends define an opening for receiving a part of a conveyor, each leg including an engagement formation for engaging with the conveyor part, and a web member extending from the proximal end of one leg to the proximal end of the other leg, the web member being configured to provide a structural connection between the proximal ends of the legs.

20. The article carrier of any of the preceding claims wherein the roller comprises:
a hub portion configured to provide or receive an axle, the hub portion comprising a first material having a first hardness;
an article contact portion engaged with the hub portion, the article contact portion being configured to at least partially support an article, and comprising a second material having a second hardness, and
wherein the second hardness is less than the first hardness.

21. A conveyor comprising at least one article carrier of any of the preceding claims and a tipping actuator.

22. The conveyor of claim 21 wherein the tipping actuator comprises:
a frame;
a trigger member pivotally mounted on the frame by a pivot connection and moveable between a non-triggering position and a triggering position;
a plurality of actuators, the actuators being energisable to move the trigger member to the non-triggering position or the triggering position, wherein one actuator is mounted closer to the pivot than the other.

23. The conveyor of claim 22 wherein the trigger comprises a carrier contacting surface and the trigger is configured to rotate upwardly into the triggering position whereby the carrier contacting surface is oriented to contact an article carrier to thereby tip the carrier.

24. The conveyor of claim 22 or claim 23 wherein the carrier contacting surface is provided on one side of the pivot connection and an arm is provided on the other side of the pivot connection.

25. The conveyor of claim 22 wherein the actuators act on the arm to move the trigger member to the non-triggering position or triggering position.
